(19) United States
(12) Patent Application Publication
(10) Pub. No.: US 2026/0104024 A1
(43) Pub. Date: Apr. 16, 2026

(54) MOUNTING STRUCTURE FOR SOUND ABSORBER IN AIR CLEANER

(71) Applicant: TOYOTA BOSHOKU KABUSHIKI KAISHA, Aichi-ken (JP)

(72) Inventor: Hiroyuki YOSHIMURA, Nagoya-shi (JP)

(73) Assignee: TOYOTA BOSHOKU KABUSHIKI KAISHA, Aichi-ken (JP)

(21) Appl. No.: 19/354,169

(22) Filed: Oct. 9, 2025

(30) Foreign Application Priority Data
Oct. 16, 2024 (JP) 2024-180561

(51) Int. Cl. F02M 35/12; F02M 35/02; F02M 35/024; F02M 35/14

(52) U.S. Cl. CPC F02M 35/1283; F02M 35/0201; F02M 35/02416; F02M 35/14

(57) ABSTRACT

A mounting structure for a sound absorber in an air cleaner is used to attach a sound absorber to a case of the air cleaner. The case includes a first segment and a second segment that is coupled to the first segment and defines an internal space of the case together with the first segment. The sound absorber is disposed along an inner surface of the first segment. The first segment includes a positioning portion configured to position the sound absorber relative to the first segment by engaging with the sound absorber. The second segment includes a restricting portion configured to restrict lifting of the sound absorber from the inner surface by coming into contact with the sound absorber.

### CROSS-REFERENCE TO RELATED APPLICATIONS

This application is based upon and claims the benefit of priority from Japanese Patent Application No. 2024-180561, filed on October 16, 2024, the entire contents of which are incorporated herein by reference.

### BACKGROUND

### 1. Field

The present disclosure relates to a mounting structure for a sound absorber in an air cleaner.

### 2. Description of Related Art

JP3-42061U discloses an example of such a mounting structure for a sound absorber in an air cleaner. The air cleaner is provided in an intake system of an internal combustion engine to filter intake air. The air cleaner disclosed in this publication includes a bottomed box-shaped case having an inlet and an upper opening, a lidded box-shaped cap having an outlet and a lower opening, and a filter element disposed between the upper opening of the case and the lower opening of the cap. Further, the sound absorber is disposed inside the case. The sound absorber is fixed to an inner surface of the case by fixing a restraining rod to the case with a rivet in a state in which the restraining rod presses the sound absorber against the inner surface of the case.

Conventionally, the case volume of air cleaners has been increased to reduce intake noise. In such an instance, the case may be formed from multiple segments to conform to an undercut shape.

In the mounting structure for the sound absorber disclosed in the above-mentioned publication, the sound absorber is fixed to the case using the restraining rod and the rivet. Thus, dedicated components and steps are required to fix the sound absorber to the case.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A mounting structure for a sound absorber in an air cleaner according to an aspect of the present disclosure is provided. The mounting structure is employed in an air cleaner that includes a case having an inlet and a first opening, a cap having an outlet and a second opening, a filter element disposed between the first opening and the second opening, and a sound absorber disposed inside the case. The sound absorber is attached to the case. The case includes a first segment and a second segment that includes the first opening. The second segment is coupled to the first segment to define an internal space of the case together with the first segment. The sound absorber is disposed along an inner surface of the first segment. The first segment includes a positioning portion configured to position the sound absorber relative to the first segment by engaging with the sound absorber. The second segment includes a restricting portion configured to restrict lifting of the sound absorber from the inner surface by coming into contact with the sound absorber.

Other features and aspects will be apparent from the following detailed description, the drawings, and the claims.

### BRIEF DESCRIPTION OF THE DRAWINGS

FIG. 1 is a cross-sectional view of an air cleaner according to an embodiment.

FIG. 2 is a cross-sectional view taken along line 2-2 in FIG. 1.

FIG. 3A is a cross-sectional view illustrating a step that temporarily couples the sound absorber to the first segment in the embodiment.

FIG. 3B is a cross-sectional view illustrating a step that temporarily couples the second segment to the first segment.

FIG. 4 is a partial cross-sectional view illustrating the air cleaner according to a first modification.

FIG. 5 is a partial cross-sectional view illustrating the air cleaner according to a second modification.

FIG. 6 is a cross-sectional view taken along line 6-6 in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

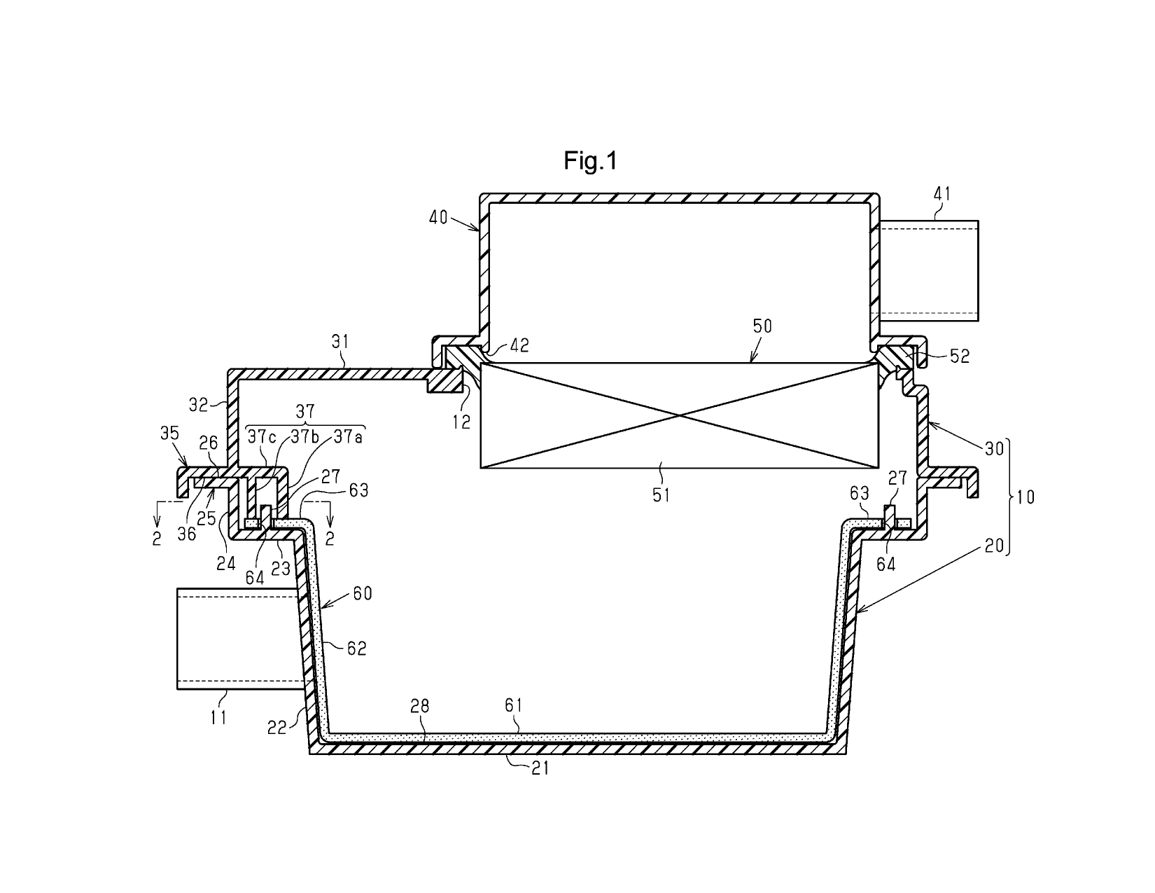

An attachment structure for a sound absorber in an air cleaner according to an embodiment will now be described with reference to FIGS. 1 to 3B. The air cleaner of the present embodiment is disposed in an intake passage of an internal combustion engine.

As shown in FIG. 1, the air cleaner includes a case 10, a cap 40, a filter element 50, and a sound absorber 60.

### Case 10 and Sound absorber 60

As shown in FIG. 1, the case 10 includes an inlet 11 and a first opening 12. The case 10 has a bottomed box shape. The sound absorber 60 is disposed inside the case 10.

The case 10 includes a first segment 20 and a second segment 30. The second segment 30 includes a first opening 12. The second segment 30 is coupled to the first segment 20 to define an internal space of the case 10 together with the first segment 20.

The first segment 20 includes a bottom wall 21, a peripheral wall 22, an extension 23, an upright wall 24, and a first peripheral portion 25. The bottom wall 21 faces the first opening 12.

The peripheral wall 22 protrudes from the periphery of the bottom wall 21 toward the second segment 30. The inlet 11 is connected to the peripheral wall 22.

The extension 23 extends outward from the periphery of the peripheral wall 22 on the side opposite the bottom wall 21 (upper side in FIG. 1).

The upright wall 24 protrudes from the outer periphery of the extension 23 toward the second segment 30.

The first peripheral portion 25 extends outward from the upright wall 24. The first peripheral portion 25 includes a first joint portion 26.

The second segment 30 includes a top wall 31, a peripheral wall 32, and a second peripheral portion 35.

The top wall 31 includes the first opening 12 and faces the bottom wall 21.

The peripheral wall 32 protrudes from the periphery of the top wall 31 toward the first segment 20.

The second peripheral portion 35 extends outward from the periphery of the peripheral wall 32 on the side opposite the top wall 31. The second peripheral portion 35 includes a second joint portion 36 facing the first joint portion 26 of the first segment 20. The direction in which the first joint portion 26 and the second joint portion 36 face each other (i.e., the vertical direction in FIG. 1) is hereinafter simply referred to as the facing direction.

The first joint portion 26 of the first segment 20 and the second joint portion 36 of the second segment 30 are joined to each other, so that the second segment 30 is coupled to the first segment 20. In the present embodiment, the joining method is welding.

The first segment 20 and the second segment 30 are made of hard resin.

The sound absorber 60 is disposed along an inner surface 28 of the first segment 20. The sound absorber 60 is shaped along at least the inner surface 28 of each of the peripheral wall 22 and the extension 23. The sound absorber 60 of the present embodiment includes a first portion 61 disposed along the inner surface 28 of the bottom wall 21, a second portion 62 disposed along the inner surface 28 of the peripheral wall 22, and a third portion 63 disposed along the inner surface 28 of the extension 23. The sound absorber 60 is made of, for example, nonwoven fabric.

The first segment 20 includes a positioning portion 27 configured to position the sound absorber 60 relative to the first segment 20 by engaging with the sound absorber 60.

The second segment 30 includes a restricting portion 37 configured to restrict the lifting of the sound absorber 60 from the inner surface 28 by coming into contact with the sound absorber 60.

The positioning portion 27 protrudes from the inner surface 28 of the first segment 20. The positioning portion 27 of the present embodiment protrudes from the inner surface 28 of the extension 23 in the facing direction. Multiple positioning portions 27 are spaced apart from each other in the extending direction of the first peripheral portion 25 (i.e., the direction orthogonal to the sheet of FIG. 1). FIG. 1 illustrates two positioning portions 27 that are respectively provided on the inner surfaces 28 of left and right extensions 23.

The sound absorber 60 includes an insertion hole 64 through which the positioning portion 27 is inserted.

The restricting portion 37 is configured to restrict the lifting of the sound absorber 60 from the inner surface 28 of the extension 23 by coming into contact with the third portion 63 of the sound absorber 60 disposed along the extension 23.

The restricting portion 37 includes a first rib 37a, a second rib 37b, and a coupling portion 37c.

The coupling portion 37c extends inward from the periphery of the peripheral wall 32 on the side opposite the top wall 31.

The first rib 37a and the second rib 37b are coupled to the coupling portion 37c and protrude toward the third portion 63.

The first rib 37a is located inward of the first segment 20 relative to the positioning portion 27.

The second rib 37b is located outward of the first segment 20 relative to the positioning portion 27.

The positioning portion 27 is located between the first rib 37a and the second rib 37b. The first rib 37a and the second rib 37b protrude in the facing direction.

As shown on the right side of FIG. 1, multiple positioning portions 27 may include a positioning portion that is not located between the first rib 37a and the second rib 37b.

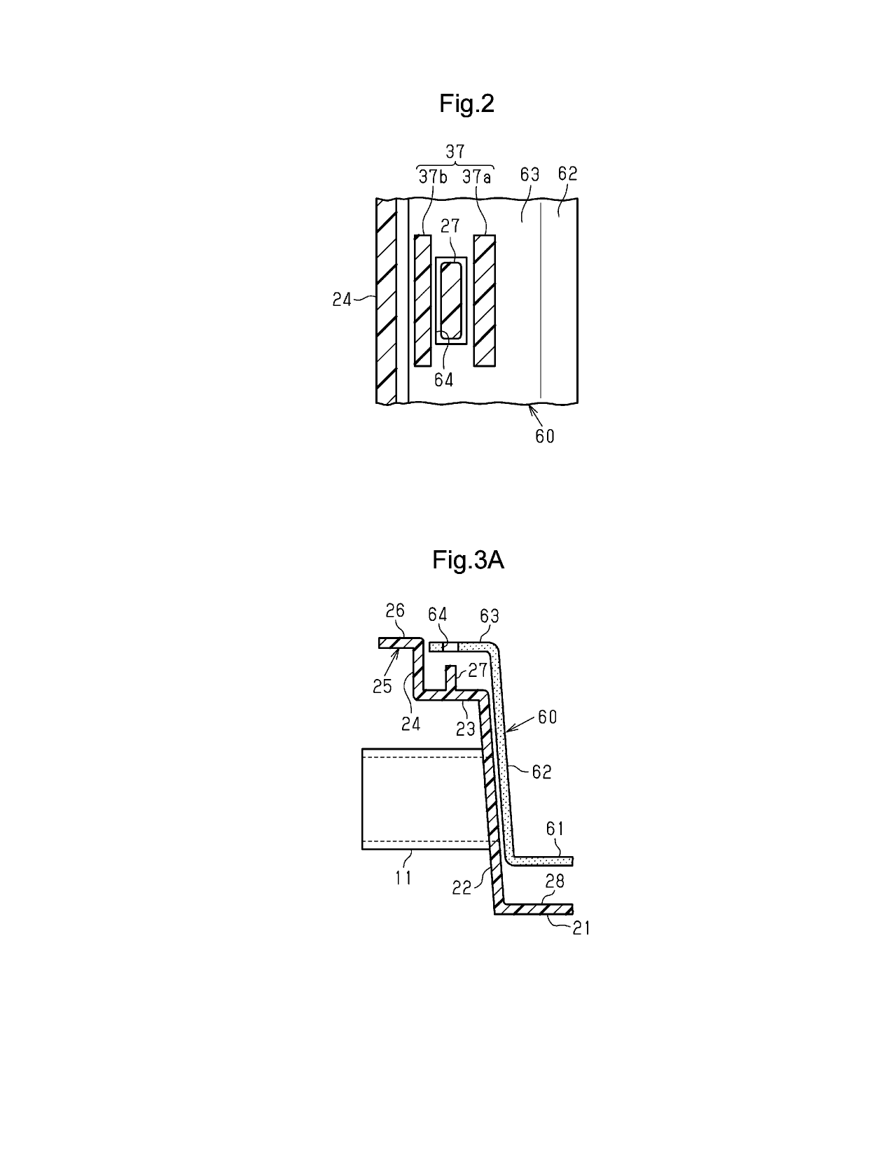

As shown in FIG. 2, the cross-sectional shape of the positioning portion 27 orthogonal to the protruding direction is rectangular. The long sides of the rectangle extend in the extending direction of the first peripheral portion 25 (i.e., the vertical direction in FIG. 2). The inner periphery of the insertion hole 64 is rectangular and slightly larger than the cross-section of the positioning portion 27.

In the present embodiment, the lengths of the ribs 37a, 37b in the extending direction of the first peripheral portion 25 are longer than the lengths of the positioning portions 27 in the extending direction. In addition, the opposite ends of the ribs 37a, 37b in the extending direction of the first peripheral portion 25 are positioned outside the opposite ends of each positioning portion 27, respectively.

Alternatively, the lengths of the ribs 37a, 37b in the extending direction of the first peripheral portion 25 may be shorter than or equal to the lengths of the positioning portions 27 in the extending direction.

### Cap 40

As shown in FIG. 1, the cap 40 includes an outlet 41 and a second opening 42. The cap 40 has a lidded box shape. The cap 40 is made of hard resin.

### Filter Element 50

As shown in FIG. 1, the filter element 50 is located between the first opening 12 and the second opening 42. The filter element 50 is of a panel type, and includes an element body 51 and a seal portion 52.

The element body 51 is formed into a panel shape by pleating a filter medium sheet made of, for example, nonwoven fabric.

The seal portion 52 is formed annularly along a peripheral portion of the element body 51. The seal portion 52 is made of closed-cell foamed resin.

The case 10 and the cap 40 are fastened to each other using a clamp (not shown), in a state in which the seal portion 52 is sandwiched between a sealing surface formed on the periphery of the first opening 12 of the case 10 and a sealing surface formed on the periphery of the second opening 42 of the cap 40. This seals the gap between these peripheries.

### Operation of the Present Embodiment

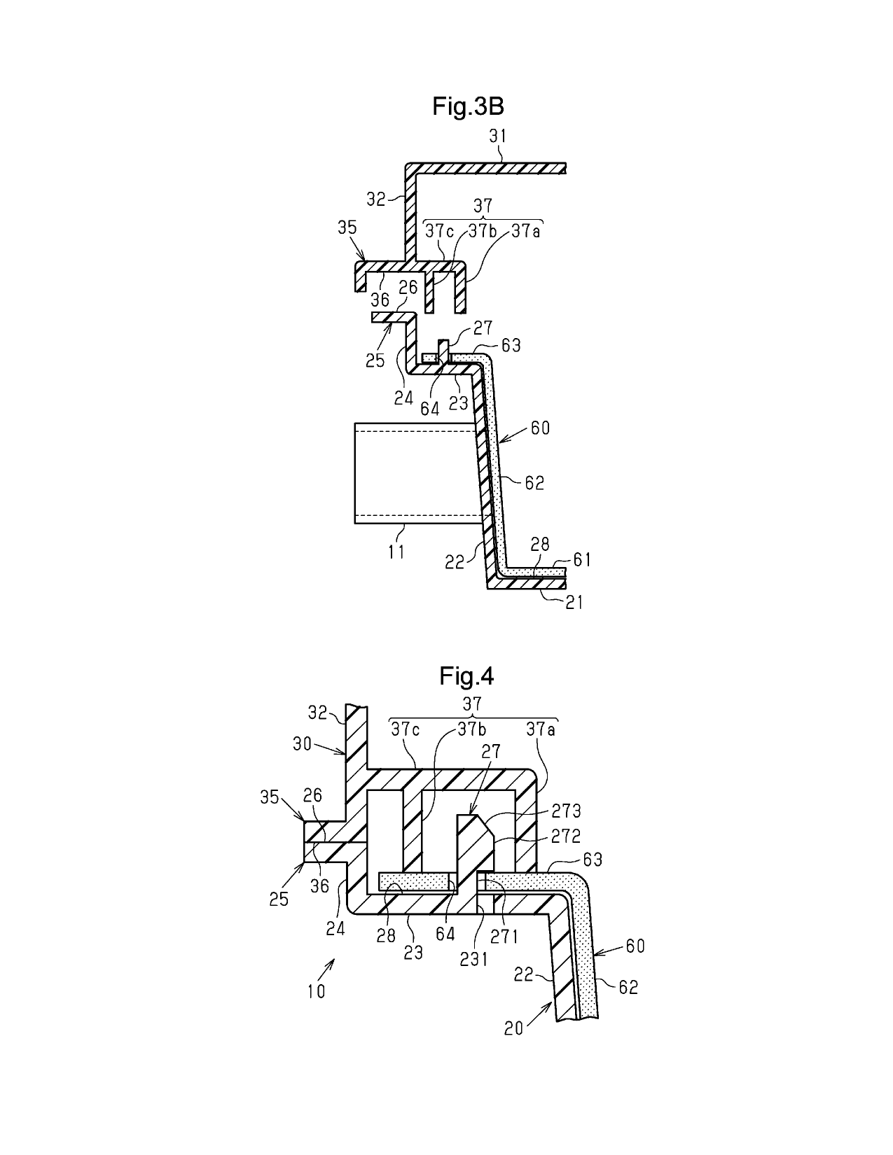

As shown in FIG. 3A, when the sound absorber 60 is disposed along the inner surface 28 of the first segment 20, the positioning portion 27 of the first segment 20 is engaged with the sound absorber 60, so that the sound absorber 60 is positioned relative to the first segment 20.

As shown in FIG. 3B, when the second segment 30 is coupled to the first segment 20, the restricting portion 37 of the second segment 30 comes into contact with the sound absorber 60, thereby restricting the lifting of the sound absorber 60 from the inner surface 28. That is, the sound absorber 60 is fixed to the case 10 by coupling the second segment 30 to the first segment 20.

### Advantages of the Present Embodiment

(1) The first segment 20 includes the positioning portion 27, which is configured to position the sound absorber 60 relative to the first segment 20 by engaging with the sound absorber 60. The second segment 30 includes the restricting portion 37 configured to restrict the lifting of the sound absorber 60 from the inner surface 28 by coming into contact with the sound absorber 60.

Such a configuration produces the above-described operation and thus eliminates the need for dedicated components and steps required to fix the sound absorber 60 to the case 10.

(2) The positioning portion 27 protrudes from the inner surface 28 of the first segment 20. The sound absorber 60 includes the insertion hole 64 through which the positioning portion 27 is inserted.

In such a configuration, the positioning portion 27 protruding from the inner surface 28 of the first segment 20 is inserted through the insertion hole 64 provided in the sound absorber 60, so that the sound absorber 60 is positioned relative to the first segment 20. This simplifies the configuration of the positioning portion 27 and thus facilitates engagement of the sound absorber 60 with the positioning portion 27.

(3) The second segment 30 is coupled to the first segment 20 by joining the first joint portion 26 to the second joint portion 36.

Such a configuration eliminates the need for components used to couple the first segment 20 to the second segment 30 and thus limits an increase in the number of components of the air cleaner.

(4) The sound absorber 60 is shaped along the inner surface 28 of each of the bottom wall 21, the peripheral wall 22, and the extension 23. This provides greater flexibility in arranging the sound absorber 60. Further, the sound absorber 60 is provided along a wider range of the inner surface 28 of the first segment 20. This increases the effect of sound absorption by the sound absorber 60.

(5) The restricting portion 37 is configured to restrict the lifting of the sound absorber 60 from the inner surface 28 of the extension 23 by coming into contact with the third portion 63 of the sound absorber 60, which is disposed along the extension 23.

In such a configuration, the third portion 63 of the sound absorber 60, in which the restricting portion 37 is in contact, is located closer to the second segment 30. This reduces the size of the restricting portion 37 of the second segment 30, particularly its size in the facing direction. This limits an increase in the amount of material used for manufacturing the second segment 30 that would result from the arrangement of the restricting portion 37.

### Modifications

The present embodiment may be modified as follows. The present embodiment and the following modifications can be combined as long as they remain technically consistent with each other.

The restricting portion 37 does not have to include the first rib 37a and the second rib 37b. Instead, the restricting portion 37 may include one of the first rib 37a and the second rib 37b.

Referring to a first modification shown in FIG. 4, the positioning portion 27 may include a retaining portion 272 configured to restrict the detachment of the sound absorber 60 by engaging with an edge of the insertion hole 64 in the sound absorber 60. In this case, the positioning portion 27 includes a body 271 that protrudes from the inner surface 28 of the extension 23 in the facing direction (i.e., the vertical direction in FIG. 4), and the retaining portion 272 protruding inward of the case 10 (i.e., toward the right side in FIG. 4) from the body 271. It is preferable that an inclined surface 273 that guides the positioning portion 27 into the insertion hole 64 be provided at a distal end (i.e., the upper end in FIG. 4) of the retaining portion 272 in the protruding direction of the body 271. The extension 23 includes a molded hole 231. The molded hole 231 and a projection that forms a recess between the retaining portion 272 and the extension 23 are provided in a part of a mold that shapes the outer surface of the first segment 20. This simplifies the configuration of a die apparatus to be used.

In the first modification shown in FIG. 4, the same or corresponding components as those of the above-described embodiment are denoted by the same reference numerals as those of the above-described embodiment. Such components will not be described in detail.

In such a configuration, in a state in which the second segment 30 is not coupled to the first segment 20, that is, in a state in which the restricting portion 37 is not in contact with the sound absorber 60, the retaining portion 272 prevents the detachment of the sound absorber 60 from the positioning portion 27.

The restricting portion 37 does not have to come into contact with the third portion 63 of the sound absorber 60, which is disposed along the extension 23. Alternatively, for example, the restricting portion 37 may be configured to restrict the lifting of the sound absorber 60 from the inner surface 28 of the bottom wall 21 by coming into contact with the first portion 61 of the sound absorber 60, which is disposed along the bottom wall 21.

The first segment 20 does not have to include the extension 23 or the upright wall 24. In this case, the first peripheral portion 25 extends outward from the periphery of the peripheral wall 22 on the side opposite the bottom wall 21.

The first segment 20 and the second segment 30 are not limited to being joined by welding, and may instead be joined by adhesive bonding or by fitting engagement. The coupling of the first segment 20 and the second segment 30 is not limited to joining, and may instead be fastened using a fastener such as a clamp.

The cross-sectional shape of the positioning portion 27 may be changed. For example, the cross-sectional shape of the positioning portion 27 may be circular. In this case, the inner periphery of the insertion hole 64 has a circular shape slightly larger than the cross-section of the positioning portion 27.

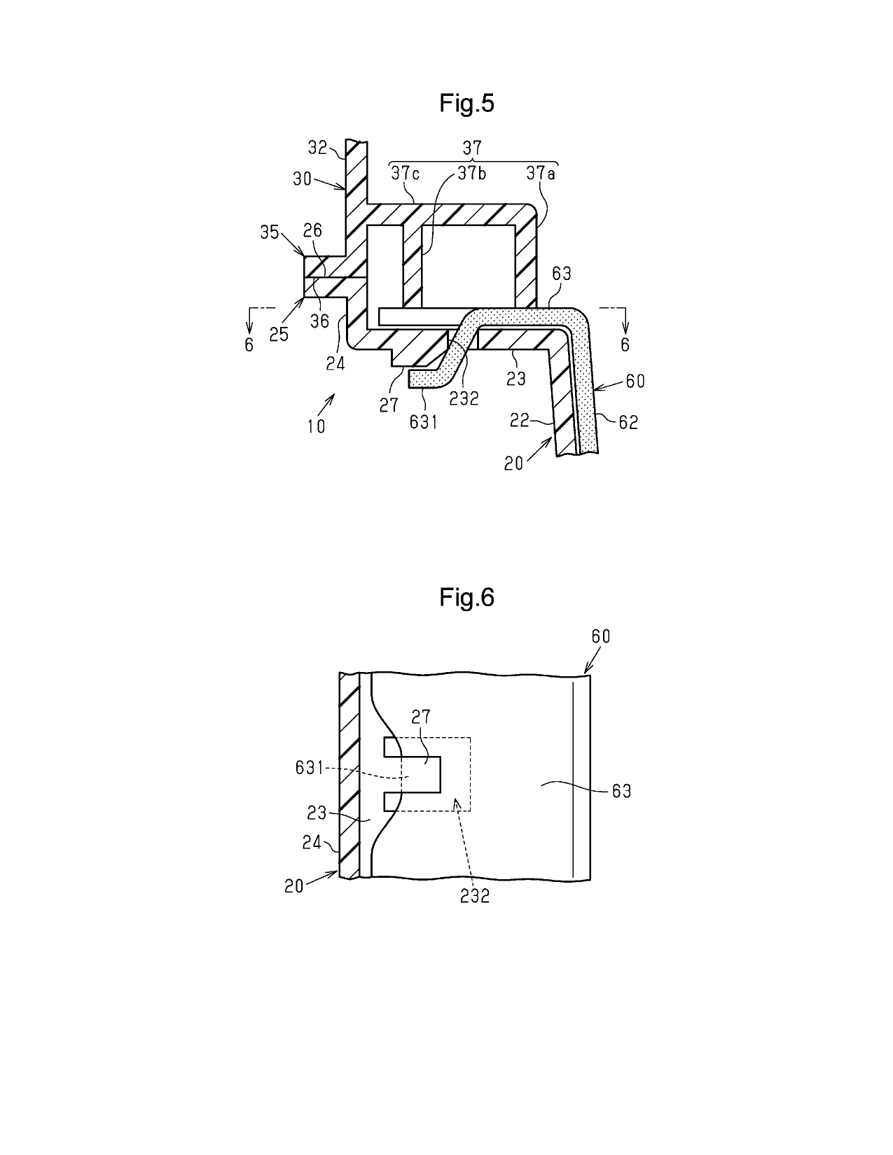

The positioning portion 27 does not have to protrude from the inner surface 28 of the first segment 20. For example, referring to a second modification shown in FIGS. 5 and 6, the extension 23 of the first segment 20 may include a U-shaped slit hole 232, and a portion of the extension 23 surrounded on three sides by the slit hole 232 may be used as the positioning portion 27. In this case, the positioning portion 27 may be engaged with the sound absorber 60 by positioning a part of an edge 631 of the third portion 63 of the sound absorber 60 on the outside of the positioning portion 27 via the slit hole 232.

In the second modification shown in FIGS. 5 and 6, the same or corresponding components as those of the above-described embodiment are denoted by the same reference numerals as those of the above-described embodiment. Such components will not be described in detail.

In the above-described embodiment, the case 10 is divided into two parts; namely, the first segment 20 and the second segment 30. However, the case 10 does not need to have such a structure. The case 10 may include at least the first segment 20 and the second segment 30. For example, the case 10 may include a third segment in addition to the first segment 20 and the second segment 30.

In the above-described embodiment, the sound absorber 60 is made of nonwoven fabric. Instead, for example, the sound absorber 60 may include a sound absorber body made of nonwoven fabric and a reinforcing member that reinforces the sound absorber body. The sound absorber 60 only needs to have a sound-absorbing function, and may be formed of a material other than nonwoven fabric, such as a foamed molded body.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A mounting structure for a sound absorber in an air cleaner, wherein
the mounting structure is employed in an air cleaner that includes:
a case having an inlet and a first opening;
a cap having an outlet and a second opening;
a filter element disposed between the first opening and the second opening; and
a sound absorber disposed inside the case,
the sound absorber is attached to the case,
the case includes:
a first segment; and
a second segment that includes the first opening, the second segment being coupled to the first segment to define an internal space of the case together with the first segment,
the sound absorber is disposed along an inner surface of the first segment,
the first segment includes a positioning portion configured to position the sound absorber relative to the first segment by engaging with the sound absorber, and
the second segment includes a restricting portion configured to restrict lifting of the sound absorber from the inner surface by coming into contact with the sound absorber.

2. The mounting structure for the sound absorber in the air cleaner according to claim 1, wherein
the positioning portion protrudes from the inner surface of the first segment, and
the sound absorber includes an insertion hole through which the positioning portion is inserted.

3. The mounting structure for the sound absorber in the air cleaner according to claim 2, wherein
the positioning portion includes a retaining portion configured to restrict detachment of the sound absorber by engaging with an edge of the insertion hole in the sound absorber.

4. The mounting structure for the sound absorber in the air cleaner according to claim 1, wherein
the first segment includes a first peripheral portion having a first joint portion,
the second segment includes a second peripheral portion having a second joint portion, the second joint portion facing the first joint portion, and
the second segment is coupled to the first segment by joining the first joint portion to the second joint portion.

5. The mounting structure for the sound absorber in the air cleaner according to claim 1, wherein
the first segment includes:
a bottom wall;
a peripheral wall protruding from a periphery of the bottom wall toward the second segment;
an extension that extends outward from a periphery of the peripheral wall on a side opposite the bottom wall;
an upright wall protruding from an outer periphery of the extension toward the second segment; and
a first peripheral portion extending outward from the upright wall, and
the sound absorber is shaped along at least the inner surface of each of the peripheral wall and the extension.

6. The mounting structure for the sound absorber in the air cleaner according to claim 5, wherein
the restricting portion is configured to restrict lifting of the sound absorber from the inner surface of the extension by coming into contact with a portion of the sound absorber disposed along the extension.
